(19) United States
(12) Patent Application Publication
(10) Pub. No.: US 2026/0002281 A1
(43) Pub. Date: Jan. 1, 2026

(54) METHOD FOR THE ADJACENT ELECTRODEPOSITION OF A METAL-ORGANIC FRAMEWORK COATING ON A POROUS SUBSTRATE

(71) Applicants: Zhaoyang FAN, Phoenix, AZ (US); Xueyan LIN, Tempe, AZ (US)

(72) Inventors: Zhaoyang FAN, Phoenix, AZ (US); Xueyan LIN, Tempe, AZ (US)

(73) Assignee: Arizona Board of Regents on Behalf of Arizona State University, Scottsdale, AZ (US)

(21) Appl. No.: 19/238,178

(22) Filed: Jun. 13, 2025

Related U.S. Application Data
(60) Provisional application No. 63/665,223, filed on Jun. 27, 2024.

(51) Int. Cl. C25D 9/02; C25D 7/00; H01M 10/052; H01M 50/403; H01M 50/417; H01M 50/451

(52) U.S. Cl. CPC C25D 9/02; C25D 7/00; H01M 10/052; H01M 50/403; H01M 50/417; H01M 50/451

(57) ABSTRACT

A method for the adjacent electrodeposition of a metal-organic framework (MOF) on a porous membrane is disclosed. The method includes placing the porous membrane between a cathode and an anode in an electrodeposition setup with the porous membrane separated from the cathode by less than 6 mm, and introducing a solution having a ligand and a metal ion source into the electrodeposition setup, between the anode and the cathode. The method then includes applying a bias to the cathode to reduce water and deprotonate the ligand thereby increasing a concentration of metal cations and deprotonated ligand anions between the porous membrane and the cathode, resulting in the nucleation and growth of a MOF film directly on the porous membrane. The MOF film is conformal. The porous membrane is insulating polypropylene, the MOF is ZIF-8, the metal cations are Zn²⁺, and the deprotonated ligand anion is 2-methylimidazolate (MIM-).

### RELATED APPLICATIONS

This application claims the benefit of U.S. provisional patent application 63/665,223, filed Jun. 27, 2024 titled “METHOD FOR THE ADJACENT ELECTRODEPOSITION OF A METAL-ORGANIC FRAMEWORK COATING ON A POROUS SUBSTRATE,” the entirety of the disclosure of which is hereby incorporated by this reference.

### STATEMENT REGARDING FEDERALLY SPONSORED RESEARCH

This invention was made with government support under 2103582, 2122921 and 2129983 awarded by the National Science Foundation. The government has certain rights in the invention.

### TECHNICAL FIELD

Aspects of this document relate generally to battery and electrochemical capacitor separators and the deposition of MOF on a porous membrane.

### BACKGROUND

Demands for electrified transportation and renewable energy has intensified the need for high-performance electrical energy storage devices. Lithium-ion batteries (LIB) are currently playing a dominant role among these devices, but are hampered by cost, material availability, and low capacity. There are also efforts to move beyond LIB. The next generation of lithium-based batteries includes Li-metal (LMB) and Li-sulfur (LSB) batteries. Li-metal batteries use Li-metal to replace the traditional graphite anode of LIB. This results in a much larger energy density.

However, the utility of current LMB technology is held back by a number of drawbacks. One of the biggest problems with using a Li-metal anode is that, during charging, localized high lithium ion flux results in Li-ions being unevenly deposited onto the anode, forming needle-like deposits called dendrites. The dendrites can grow through the separator and reach the cathode, causing a short circuit. This can lead to battery failure, potentially of a hazardous nature (e.g., fire, explosion, etc.).

Li-sulfur batteries use a Li-metal anode with a sulfur cathode. In addition to a large energy density, Li-sulfur batteries also have the advantages of the low cost, abundant supply, and light weight of sulfur. However, LSB also suffer from dendrite formation on the lithium anode. Besides the notorious dendrite challenge associated with the Li-metal anode, Li—S chemistry also suffers from a lithium polysulfide (LiPS) shuttling problem. With a cyclic ring (cyclo-octasulfur) structure, sulfur in the cathode undergoes stepwise reduction during discharge, forming long-chain and short-chain polysulfides. The long-chain LiPS (Li₂Sₓ,4<=x<=8) can easily dissolve in the used ether-based electrolyte and diffuses out of the cathode matrix to the anode side, where it reduces and then transports back to the cathode. The resulting polysulfide shuttle effect leads to low Coulombic efficiency, anode corrosion, rapid capacity decay, and fast battery failure, sabotaging the practical utilization of Li—S battery technology.

Efforts to overcome these problems have included attempts to improve the separator. The primary function of the separator in a Li-based battery is to electrically isolate the active cathode and anode materials but allow free transportation of Li+ ions. The extruded polyolefin films used in commercial separators cannot, by themselves, address the challenges of LiPS shuttling and Li-metal dendrite formation. A separator allowing active LiPS shuttling between two electrodes does not fulfill its essential function. Therefore, modifying the separator to shut off LiPS shuttling is an attractive strategy. Blocking the LiPS pathway can be achieved via pore size downscaling to a few nanometers that allow Li+ transportation but not LiPS.

Porous membranes (PMs) are commonly used as battery separators positioned between the anode and cathode electrodes in a battery to allow for ionic migration but prevent shorting of the electrodes. Functional PMs may be assembled with metal-organic framework (MOF) materials deposited on the surface of the membrane to enhance their performance.

Typically, the porous membrane used as a separator is an insulator. Conventional methods for depositing MOF materials on the porous membrane require the deposition of a pre-metal coating to act as a cathode in the electrodeposition of the MOF materials. However, this electrodeposition method faces substantial challenges. Since battery separators are insulating materials, electrodeposition on them requires a few nanometer thick layer of metal to be deposited on the separator first through sputtering, evaporation, or other methods.

Unfortunately, this metal deposition introduces a number of complications. This additional step increases the cost of the separator, particularly because these metals are often expensive. Additionally, this thin (i.e., few nm-thick) conducting layer on an insulating substrate presents challenges in attaining a consistent current distribution for depositing MOFs over larger areas. Also, if both sides of the separator need to be coated with MOF, then metal must be deposited on both sides first. This increases the cost, and also increases the possibility of an electrical shortage across the separator. Finally, some applications may not be compatible with this pre-coating metal deposition.

### SUMMARY

According to one aspect, a method for the adjacent electrodeposition of a metal-organic framework (MOF) on a porous membrane includes placing the porous membrane between a cathode and an anode in an electrodeposition setup with the porous membrane separated from the cathode by less than 6 mm, introducing a solution having a ligand and a metal ion source into the electrodeposition setup, between the anode and the cathode, and applying a bias to the cathode to reduce water and deprotonate the ligand thereby increasing a concentration of metal cations and deprotonated ligand anions between the porous membrane and the cathode, resulting in the nucleation and growth of a MOF film directly on the porous membrane, the MOF film being conformal. The porous membrane is insulating.

Particular embodiments may comprise one or more of the following features. The porous membrane may be one of polypropylene or polyethylene. The MOF may be ZIF-8. The MOF may be one of ZIF-67, Co—Zn bimetallic ZIF, MOF-5, HKUST-1, and UiO-66. The metal cations may be Zn²⁺. The porous membrane may be separated from the cathode by less than 1 mm. The porous membrane may be in direct contact with the cathode. The ligand may be 2-methylimidazole (MIM). The method may also include pre-seeding the porous membrane with MOF particles to facilitate MOF nucleation. The bias may be a constant current. The bias may be applied until a cutoff voltage is reached. The cutoff voltage may be 2.5 V.

According to another aspect of the disclosure, a method for the adjacent electrodeposition of a metal-organic framework (MOF) on a porous membrane includes placing the porous membrane between a cathode and an anode in an electrodeposition setup with the porous membrane separated from the cathode by less than 6 mm, introducing a solution having a ligand and a metal ion source into the electrodeposition setup, between the anode and the cathode, and applying a bias to the cathode to reduce water and deprotonate the ligand thereby increasing a concentration of metal cations and deprotonated ligand anions between the porous membrane and the cathode, resulting in the nucleation and growth of a MOF film directly on the porous membrane, the MOF film being conformal. The porous membrane is polypropylene and is insulating. The MOF is ZIF-8. The metal cations are Zn2+. The deprotonated ligand anions is 2-methylimidazolate (MIM-).

Particular embodiments may comprise one or more of the following features. The porous membrane may be separated from the cathode by less than 1 mm. The porous membrane may be in direct contact with the cathode. The bias may be a constant current. The bias may be applied until a cutoff voltage of 2.5 V is reached.

According to yet another aspect of the disclosure, a method for assembling a lithium-metal anode-based battery cell includes fabricating a molecule active regulated separator (MARS) through the adjacent electrodeposition of a metal-organic framework on a porous membrane by placing the porous membrane between a cathode and an anode in an electrodeposition setup with the porous membrane separated from the cathode by less than 6 mm, introducing a solution having a ligand and a metal ion source into the electrodeposition setup, between the anode and the cathode, and applying a bias to the cathode to reduce water and deprotonate the ligand thereby increasing a concentration of metal cations and deprotonated ligand anions between the porous membrane and the cathode, resulting in the nucleation and growth of a conformal MOF film directly on the porous membrane to form the MARS. The method also includes directly coupling the MARS to a lithium-metal anode (LMA) such that the MOF film of the MARS is mated with the LMA, and completing the battery cell by introducing an electrolyte between the MARS and a battery cathode. The porous membrane is insulating.

Particular embodiments may comprise one or more of the following features. An interface between the MARS and the LMA may be electrolyte-free. The MARS may be less than 10 μm thick.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A is a schematic view of a of a conventional electrodeposition method for depositing MOF materials on a porous membrane;

FIG. 1B is a schematic view of a process for forming porous ZIF-8;

FIG. 2 is a schematic view of an adjacent electrodeposition method for directly depositing MOF materials on a porous membrane;

FIG. 3 is a schematic view of a process for assembling a lithium-metal anode-based battery cell;

FIGS. 4A and 4B are SEM images of 8 μm thick polypropylene (PP) with a ZIF-8 coating.

FIG. 4C is an SEM image of commercial 8 μm PP;

FIG. 4D is a cross-sectional SEM image of the ZIF-8 coated 8 μm PP of FIGS. 4A and 4B;

FIG. 5A shows a lithium plating and stripping voltage profile using Li—Li symmetric cells;

FIG. 5B shows the rate capabilities of Li—S full cells;

FIG. 5C shows galvanostatic charge-discharge voltage curves for ZIF-8 AED-coated 8 μm PP from 0.1 to 1 C;

FIG. 5D shows long-term cyclic stability of Li—S cells with different separators at 1 C; and

FIGS. 6A and 6B show the impedance spectra of supercapacitors with 1 M TEABF4 in acetonitrile as the electrolyte 306, using a ZIF-8 AED-coated 8 μm PP separator and a pristine 8 μm PP separator, respectively.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Demands for electrified transportation and renewable energy has intensified the need for high-performance electrical energy storage devices. Lithium-ion batteries (LIB) are currently playing a dominant role among these devices, but are hampered by cost, material availability, and low capacity. There are also efforts to move beyond LIB. The next generation of lithium-based batteries includes Li-metal (LMB) and Li-sulfur (LSB) batteries. Li-metal batteries use Li-metal to replace the traditional graphite anode of LIB. This results in a much larger energy density.

However, the utility of current LMB technology is held back by a number of drawbacks. One of the biggest problems with using a Li-metal anode is that, during charging, localized high lithium ion flux results in Li-ions being unevenly deposited onto the anode, forming needle-like deposits called dendrites. The dendrites can grow through the separator and reach the cathode, causing a short circuit. This can lead to battery failure, potentially of a hazardous nature (e.g., fire, explosion, etc.).

Li-sulfur batteries use a Li-metal anode with a sulfur cathode. In addition to a large energy density, Li-sulfur batteries also have the advantages of the low cost, abundant supply, and light weight of sulfur. However, LSB also suffer from dendrite formation on the lithium anode. Besides the notorious dendrite challenge associated with the Li-metal anode, Li—S chemistry also suffers from a lithium polysulfide (LiPS) shuttling problem. With a cyclic ring (cyclo-octasulfur) structure, sulfur in the cathode undergoes stepwise reduction during discharge, forming long-chain and short-chain polysulfides. The long-chain LiPS (Li₂Sₓ,4<=x<=8) can easily dissolve in the used ether-based electrolyte and diffuses out of the cathode matrix to the anode side, where it reduces and then transports back to the cathode. The resulting polysulfide shuttle effect leads to low Coulombic efficiency, anode corrosion, rapid capacity decay, and fast battery failure, sabotaging the practical utilization of Li—S battery technology.

Efforts to overcome these problems have included attempts to improve the separator. The primary function of the separator in a Li-based battery is to electrically isolate the active cathode and anode materials but allow free transportation of Li+ ions. The extruded polyolefin films used in commercial separators cannot, by themselves, address the challenges of LiPS shuttling and Li-metal dendrite formation. A separator allowing active LiPS shuttling between two electrodes does not fulfill its essential function. Therefore, modifying the separator to shut off LiPS shuttling is an attractive strategy. Blocking the LiPS pathway can be achieved via pore size downscaling to a few nanometers that allow Li+ transportation but not LiPS.

Porous membranes (PMs) are commonly used as battery separators positioned between the anode and cathode electrodes in a battery to allow for ionic migration but prevent shorting of the electrodes. Functional PMs may be assembled with metal-organic framework (MOF) materials deposited on the surface of the membrane to enhance their performance.

In addition to batteries, MOF-functionalized PMs can also be used as the separator in supercapacitors. In comparison to conventional polymer separators, MOF functionalization improves the wettability of the separator by both aqueous and organic electrolytes, thus improve the electrolyte conductivity across the separator. The improved conductivity will reduce the parasitic resistance of the supercapacitors. It is particularly crucial for ac-filtering supercapacitors (electrochemical capacitors) working at hundreds to kilohertz frequencies.

Typically, the porous membrane used as a separator is an insulator. Conventional methods for depositing MOF materials on the porous membrane require the deposition of a pre-metal coating to act as a cathode in the electrodeposition of the MOF materials. MOFs consist of metal nodes (ions or clusters) coordinated with organic ligands, forming highly porous and crystalline networks. Zeolitic Imidazolate Frameworks (ZIFs), a subclass of MOFs, feature tetrahedrally coordinated metal centers linked by imidazolate-based ligands, resulting in zeolite-like topologies with excellent thermal and chemical stability

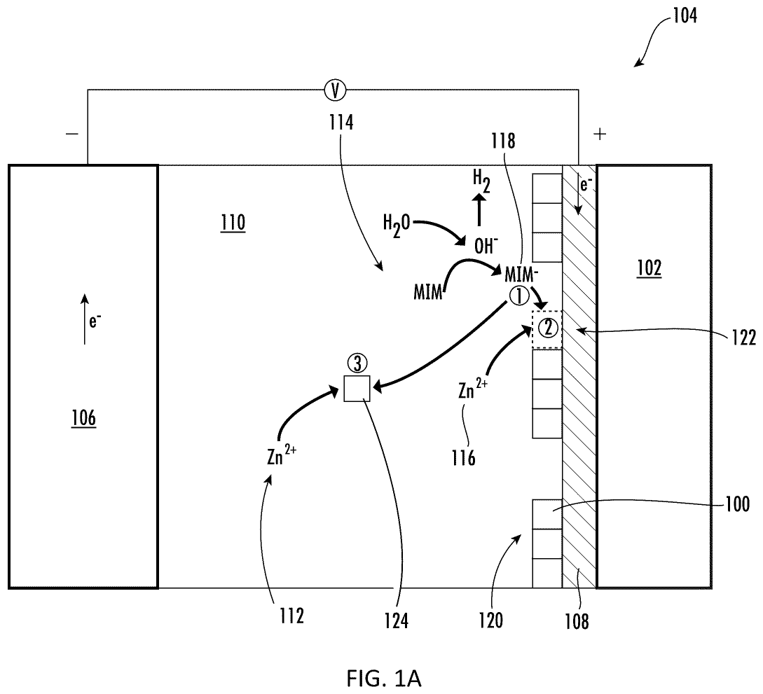

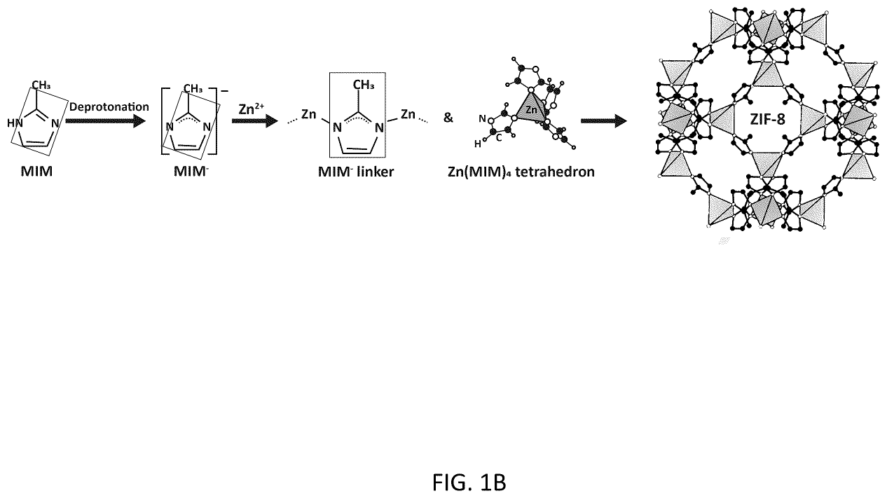

FIG. 1A is a schematic view of a non-limiting example of a conventional electrodeposition method for depositing MOF 100 materials on a porous membrane 102. Specifically, FIG. 1A shows the electrodeposition of a MOF film 120 (i.e., ZIF-8) onto an insulating porous membrane 102 (e.g., polypropylene) within an electrodeposition setup 104. The insulating PM 102 is coated with a thin conductive layer (e.g., Au, Pt, etc.) that will act as the cathode 108 that will be biased to drive the electrodeposition. The anode 106 is an inert electrode where water oxidation occurs to generate protons. Between the anode 106 and the cathode 108 is an aqueous solution 110 comprising a metal ion source 112 (i.e., a Zn (II) salt such as zinc acetate dihydrate) and a ligand 114. In this non-limiting example, the ligand 114 is 2-methylimidazole (MIM, C₄H₆N₂).

During the electrodeposition, water is reduced on the cathode surface to produce OH⁻, which in turn promote the deprotonation of MIM when it diffuses to near the cathode surface:

MIM+OH⁻→MIM-+H₂O (see reaction ‘1’ in FIG. 1A)

Meanwhile, the metal cations 116 (i.e., Zn²⁺) in the solution 110 migrates to the cathode 108, coordinating with deprotonated ligand anions 118 (i.e., MIM⁻):

Zn²⁺+2MIM⁻→Zn(MIM)₂, (see reaction ‘2’ in FIG. 1A)

This leads to the nucleation and growth of a MOF film 120 (i.e., a ZIF-8 film) directly on the cathode 108 surface of the porous membrane 102.

FIG. 1B shows the structure formation process of porous ZIF-8. Upon deprotonation, 2-methylimidazole (C₄H₆N₂, MIM) forms 2-methylimidazolate (C₄H₅N₂⁻, MIM⁻), where the deprotonated nitrogen coordinates strongly with Zn²⁺ ions. The second nitrogen atom, bearing a lone pair of electrons, may weakly interact with another Zn²⁺ ion. Consequently, each MIM-bridges two Zn²⁺ centers, while each Zn²⁺ ion is tetrahedrally coordinated by four MIM-ligands, constructing a microporous framework with pores approximately 11.6 Å in diameter and pore apertures around 3.4 Å. The ZIF-8 framework contains Zn²⁺ nodes coordinated by imidazolate linkers, enabling selective interactions with electrolyte anions through Lewis acid-base mechanisms. This can be leveraged to immobilize anions and enhance the selectivity of the separator.

Electrodeposition of MOFs 100 tends to be a quasi-self-limiting process. Because MOFs 100 are typically electrically insulating, growth occurs preferentially in regions where the electric field drives ion transport. As deposition progresses, the locally deposited MOF 100 layer increases the resistance to ionic current, naturally suppressing further growth in already coated areas. This dynamic promotes continued MOF 100 formation at uncoated or thinner regions, often associated with defects, pinholes, or grain boundary gaps and depicted as a local defect 122 in FIG. 1A. Consequently, the MOF film 120 self-adjusts during deposition to form a compact, uniform, and electrically blocking layer. Such electrodeposited MOF films 120 exhibit intergrown, leak-free grain boundaries, as evidenced by their excellent gas separation performance

This electrodeposition method faces substantial challenges. Since battery separators are insulating materials, electrodeposition on them requires a few nanometer thick layer of metal to be deposited on the separator first through sputtering, evaporation, or other methods. For example, Pt, Au or other catalytic metals that can promote water reduction to form H₂ are preferred. The deposited metal is used as the cathode 108 in electrodeposition of ZIF.

Unfortunately, this metal deposition introduces a number of complications. This additional step increases the cost of the separator, particularly because these metals are often expensive. Additionally, this thin (i.e., few nm-thick) conducting layer on an insulating substrate presents challenges in attaining a consistent current distribution for depositing MOFs 100 over larger areas. Also, if both sides of the separator need to be coated with MOF 100, then metal must be deposited on both sides first. This increases the cost, and also increases the possibility of an electrical shortage across the separator. Finally, some applications may not be compatible with this pre-coating metal deposition.

In addition to these complications, the conventional electrodeposition method itself is not efficient. For example, in the electrodeposition of ZIF in FIG. 1A, MIM-migrates away from the cathode 108 and forms coordination bonds with Zn²⁺ in the bulk solution 110 (reaction ‘3’ in FIG. 1A). This reaction leads to pronounced parasitic MOF particle 124 precipitation in the solution, but not on the porous membrane 102.

Contemplated herein is a method for adjacent electrodeposition, which deposits a metal-organic framework 100 (MOF) directly on the surface and within the pores of a porous membrane 102, without the need of a pre-metal coating. These MOF-coated porous membranes are well adapted for use as battery separators. In the adjacent electrodeposition of ZIF-8, the cathodic reaction primarily involves water reduction, and MIM 114 deprotonation—and thus ZIF-8 formation—occurs in the vicinity adjacent to the cathode 108, rather than directly on the cathode surface as in conventional electrodeposition. Therefore, if a PM substrate 102 is positioned adjacent to the cathode 108, within a zone where Zn²⁺ ions 116 and MIM-species are supersaturated, ZIF-8 nucleation and growth are expected to occur on the PM's rough surface. According to various embodiments, a porous membrane 102 is placed closely in front of a cathode 108 where metal cations 116 of choice deposit, nucleate, and grow MOF particles 124 directly on the porous membrane 102. This forms a MOF film 120 on the porous membrane 102 and within its pores, rather than on a layer of metal coating the membrane. In some embodiments, the porous membrane 102 may be pre-seeded with MOF particles 124 to facilitate this nucleation.

As discussed above, one application for the contemplated method for adjacent electrodeposition is the preparation of a more effective battery separator. Battery separators that have been prepared using the contemplated adjacent electrodeposition method have been tested in battery cells, and have shown improved cycling and exhibited a high capacity.

It should be noted that will the following discussion will focus in applying the contemplated adjacent electrodeposition (AED) method to the preparation of porous battery separators, this method for depositing MOF materials on a membrane without needing a pre-metal coating may be applied advantageously in many other contexts. Other exemplary areas of application include, but are not limited to, gas separation (e.g. propene/propane separation), carbon dioxide capture (e.g., MOF membranes can selectively capture CO₂ from flue gases, etc.), hydrogen purification (e.g., used in hydrogen production processes to separate hydrogen from other gases like CO, CO₂, and CH₄), oxygen and nitrogen separation (e.g., MOF membranes can efficiently separate O₂ from N₂, which is valuable in industries requiring high-purity gases), water treatment (e.g., desalination: MOF membranes can effectively remove salt from seawater through reverse osmosis or nanofiltration, providing fresh water; removal of contaminants: capable of removing heavy metals, organic pollutants, and other contaminants from wastewater, enhancing water quality), air purification (e.g., by removing pollutants such as formaldehyde, ammonia, and sulfur compounds from indoor air, and capture and removal of VOCs from industrial emissions), molecular sieving in chemical and petrochemical industries and in pharmaceutical industry, catalysis, sensors (e.g., chemical and biological sensors, etc.), protective coatings (e.g., anticorrosive, etc.), electronic devices, and the like. By leveraging the unique properties of MOFs and the advantages of the AED method, these applications demonstrate the versatility and broad impact of AED technology across various fields and industries

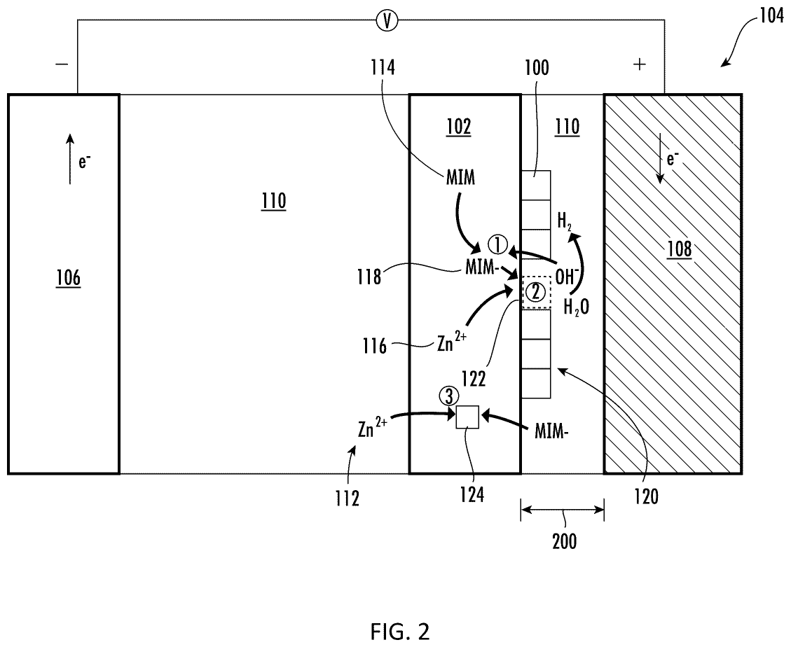

FIG. 2 is a schematic view of a non-limiting example of an application of the contemplated AED method for the direct deposition of a metal-organic framework 100 on a porous membrane 102, which eliminates the need for a preparatory metal deposition on the porous membrane 102 and also prevents precipitation of MOF particles 124 in the solution 110. While this will be discussed in the context of a specific embodiment where the MOF 100 is ZIF-8, it should be noted that the contemplated AED method may be applied using a variety of other materials and frameworks including, but not limited to, ZIF-67, Co—Zn bimetallic ZIF, MOF-5, HKUST-1, and UiO-66.

As shown, the AED method contemplated herein makes use of a conventional electrodeposition setup 104 having an anode 106 and a cathode 108 separated by a solution 110. According to various embodiments, the anode 106 is an inert electrode where water oxidation occurs to generate protons. The cathode reaction is water reduction to produce OH⁻ and H₂. Although zinc plating (E⁰=−0.76 V vs. SHE) is thermodynamically favored over water reduction (E⁰=−0.83 V), under mild current and overpotential conditions, water reduction is preferred due to the much higher concentration of water (˜55 M) relative to Zn²⁺ (˜mM), and the higher nucleation barrier for Zn. This preferential H₂ evolution allows for a controlled MOF deposition. To avoid Zn deposition, inert conductive materials such as carbon cloth, glassy carbon, and fluorine-doped tin oxide (FTO)-coated glass may be utilized according to various embodiments, as they promote water reduction without facilitating Zn plating.

Similar to the conventional MOF deposition technique described above, the contemplated AED method introduces a porous membrane 102 to the electrodeposition setup 104. However, instead of using a thin conductive layer deposed on a surface of the porous membrane 102 as a cathode 108 that is facing the anode 106, the AED method places the porous membrane 102 close to the cathode 108 with the deposited surface facing the cathode 108 such that the porous membrane 102 is between the anode 106 and the cathode 108, as shown in FIG. 2.

In some embodiments, the porous membrane 102 is positioned closely in front of the cathode 108. Typical distances are between 0 mm and a few mm. In some embodiments, the separation 200 between the porous membrane 102 and the cathode 108 is no more than 6 mm. In other embodiments, the separation 200 is less than 1 mm. In most cases, the smaller the separation 200, the better. However, in other cases, there may be some degree of distance needed to be compatible with other aspects of the fabrication process. For example, in embodiments employing a roll-by-roll fabrication process, a small distance is needed for mechanical moving. The separation 200 needed will depend upon the minimum required by the particular equipment being used. In still other embodiments, the porous membrane 102 may be in direct contact with the cathode 108.

The porous membrane 102 is insulating. In some embodiments, the porous membrane 102 is a polymer membrane such as polypropylene. Other exemplary porous membrane 102 include, but are not limited to, inorganic solid membranes, organic membranes, other flexible membranes, and the like. As an option, in some embodiments, the porous membrane 102 may be pre-seeded with prefabricated MOF particles 124 to facilitate nucleation of MOF 100 upon and within the porous membrane 102. This seeding may be accomplished via soaking or spray-coating, and is introduced before the electrodeposition.

An electrolyte solution 110 containing a ligand 114 and a metal ion source 112 is introduced to the space between the anode 106 and the cathode 108 within the electrodeposition setup 104. The ligand 114 and metal ion source 112 are the precursors to the MOF 100 that will be directly deposed on the porous membrane 102, according to various embodiments. In some embodiments, including the non-limiting example shown in FIG. 2, the solution 110 may contain 2-methylimidazole (MIM) as the ligand 114 and zinc ions (Zn²⁺) from a zinc salt (i.e., metal ion source 112) as the metal cations 116, to result in the deposition of ZIF-8 on the porous membrane 102. Other embodiments may depose other MOF 100 materials including, but not limited to, ZIF-67, Co—Zn bimetallic ZIF, MOF-5, HKUST-1, UiO-66, various face-centered cubic (fcu)-MOFs (e.g., assembled from 12-connected rare-earth or zirconium hexanuclear clusters and ditopic linkers), and the like.

A bias of a constant current (e.g., ˜ 0.15 mA/cm²) is applied to the cathode 108 to electrochemically reduce water to produce OH, which in turn promotes the deprotonation of the ligand 114 near the cathode 108. In some embodiments, the bias may be limited to a cutoff voltage of 2.5 V in some embodiments. As shown in FIG. 2, after MIM (i.e., ligand 114) diffuses to near the cathode 108 and deprotonates (see reaction ‘1’), the produced deprotonated ligand anion 118 (i.e., MIM⁻) will migrate away from the cathode 108 surface towards the porous membrane 102 and the anode 106. Since concentrated Zn²⁺ cations accumulate in front of the cathode 108 under bias, the increase in concentration of metal cations 116 and deprotonated ligand anions 118 between the porous membrane 102 and cathode 108 results in the nucleation and growth of a MOF film 120 directly on the porous membrane 102 (see reaction ‘2’). According to various embodiments, this MOF film 120 is conformal.

Those MIM⁻ that manage to escape from the porous membrane 102-cathode 108 interface can be captured within the functionalized porous membrane 102 where they react with Zn²⁺ and generate MOF particles 124 within the porous membrane 102 (see reaction ‘3’). These internal MOF particles 124 enhance the porous membrane 102 performance as a battery separator, according to various embodiments.

According to various embodiments, homogeneous nucleation process within the solution 110 can be minimized by reducing the volume of bulk solution 110 (i.e., reducing the space between the anode 106 and the porous membrane 102) so that under a cathode 108 bias, most Zn²⁺ cations are accumulated at the interface and inside the porous membrane 102. According to various embodiments, the distance between the anode 106 and the porous membrane 102 depends upon the mechanical design. For example, in some embodiments, the smaller the distance the better, even to the point of a separation of 0 mm. In other embodiments, including some embodiments involving mechanical movement, a gap of 1 mm or smaller may be used.

Parasitically deprotonated MIM-will also be decreased. With low Zn²⁺ and MIM-concentration in the bulk solution 110, which has a reduced volume, the homogeneous nucleation process in the solution 110 is suppressed. By eliminating the need for metal deposition on the porous membrane 102, the contemplated AED method can be applied for roll-by-roll deposition of MOF 100 on battery separator for large-scale application.

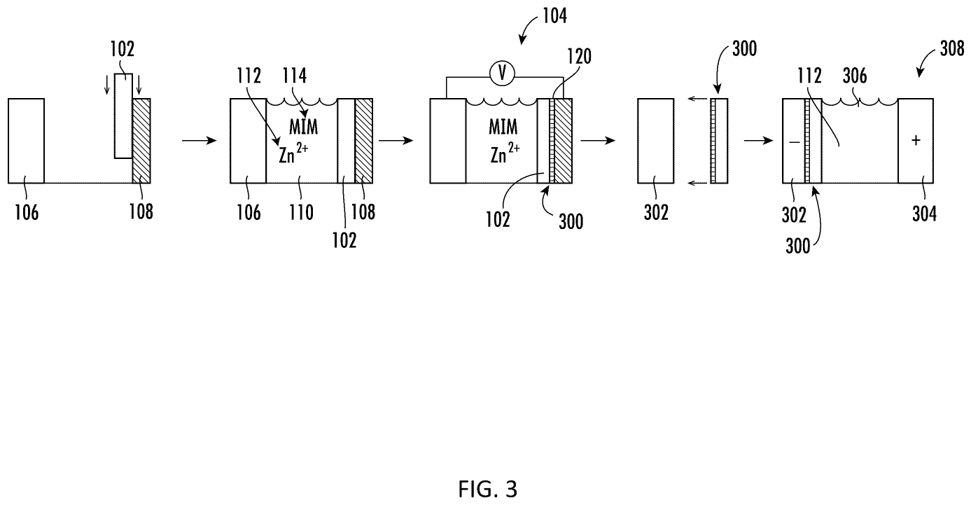

As previously discussed, the MOF-coated porous membrane produced using the contemplated AED method has numerous application. One application that the MOF-coated porous membrane is particularly well adapted for is as a battery separator. FIG. 3 is a schematic view of a non-limiting example of a process for assembling a lithium-metal anode-based battery cell 308. This process is similar to the conventional assembly process for LMA-based batteries, with two important distinctions. First, the process includes using the contemplated AED method for the fabrication of a molecule active regulated separator 300 (hereinafter MARS 300) that replaces the conventional passive battery separator. Second, the MARS 300 establishes a functionally electrolyte-free interface with the LMA. These two differences provided advantages over conventional LMA-based batteries including suppressing solvent-induced degradation, enabling controlled Li⁺ transport without continuous liquid mediation, accelerating Li⁺ transport kinetics, promoting spatially distributed desolvation, suppressing dendrite formation, and enhancing overall electrochemical stability, according to various embodiments.

As shown in FIG. 3, the MARS 300 may be fabricated through the adjacent electrodeposition of a metal-organic framework on a porous membrane 102 by placing the porous membrane 102 between a cathode 108 and an anode 106 in an electrodeposition setup 104 that has a solution 110 comprising a ligand 114 and a metal ion source 112, with the porous membrane 102 separated from the cathode 108 by less than 6 mm. When a bias is applied to the cathode 108, water gets reduced leading to the deprotonation the ligand 114 thereby increasing a concentration of metal cations 116 and deprotonated ligand anions 118 between the porous membrane 102 and the cathode 108. This results in the nucleation and growth of a conformal MOF film 120 directly on the porous membrane 102 to form the MARS 300. In some embodiments, the MARS 300 may be from tens of nanometers to less than 10 μm thick.

With the MARS 300 fabricated, the lithium-metal anode-based battery cell 308 can be assembled. As shown, the MARS 300 is directly coupled to a lithium-metal anode 302 (LMA) such that the MOF film 120 of the MARS 300 is mated with the LMA 302. In some embodiments, this interface between the MARS 300 and the LMA 302 is tight enough to be functionally electrolyte-free, even after an electrolyte 306 is added to the battery cell 308 between the MARS 300 and a battery cathode 304.

As a specific example, a MARS 300 that was fabricated in the lab showed a relatively rough and unoptimized surface of deposited ZIF-8. It was assembled into a Li—S cell with the LMA physically pressed against the ZIF-8-coated side of the MARS 300 to maintain a functional electrolyte-free interface. Liquid electrolyte 306 was added only between the MARS 300 and the cathode—consistent with the MARS architecture depicted in FIG. 3. The LMA maintained a smooth surface morphology even after 500 charge-discharge cycles, in stark contrast to the severely roughened LMA observed in cells using a conventional PP separator.

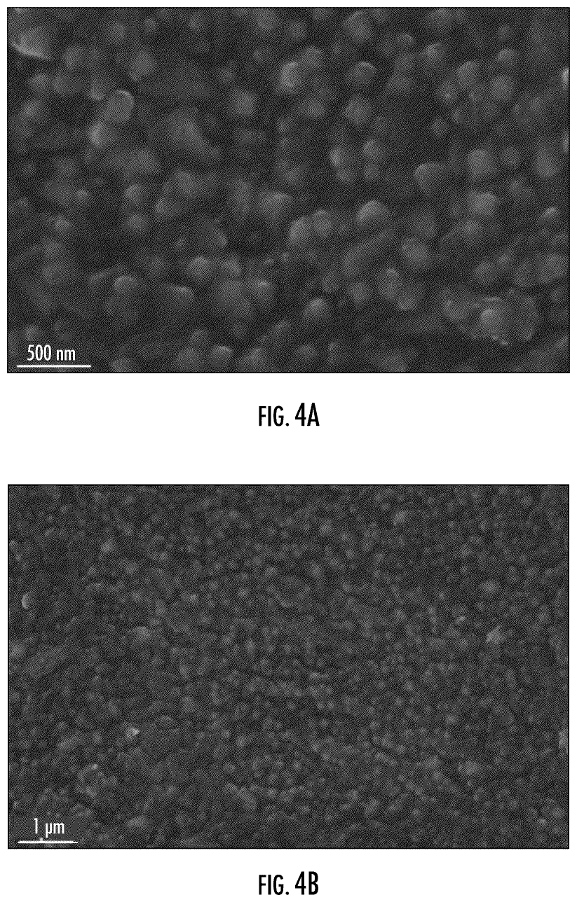

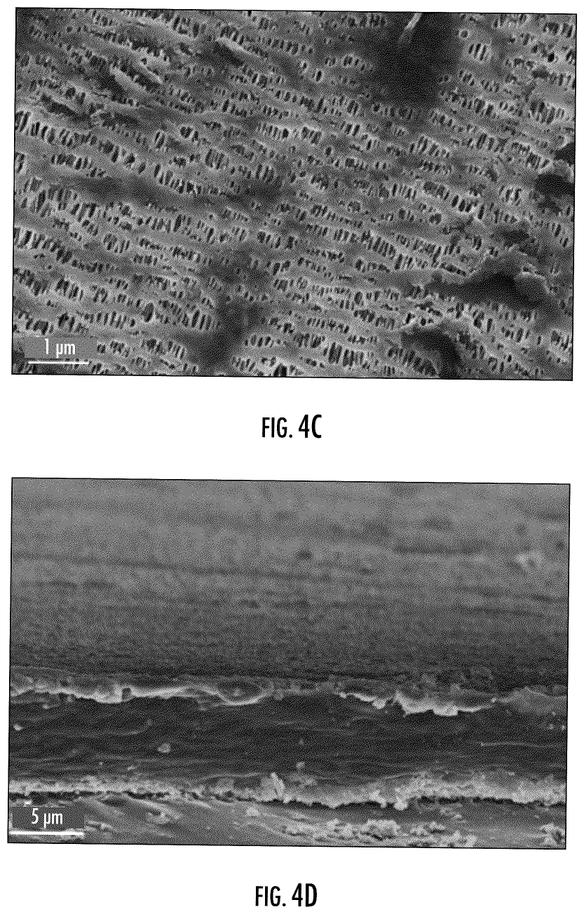

The following is a discussion of the observed properties of specific, non-limiting examples of the application of the AED method for depositing a MOF 100 (i.e., ZIF-8) on a porous membrane 102 (i.e., a polypropylene or PP battery separator). FIGS. 4A-4D explore the morphology of PP in different circumstances. Specifically, FIGS. 4A and 4B are SEM images of 8 μm thick PP with a 1 μm thick ZIF-8 coating. FIG. 4C shows an SEM image of commercial 8 μm PP. FIG. 4D shows a cross-sectional SEM image of the ZIF-8 coated 8 μm PP of FIGS. 4A and 4B. It should be noted that none of these porous membranes 102 were pre-coated with metal such as gold before using AED, as would be done using conventional methods.

As discussed above, during the cathodic deposition process, the small current promotes the deprotonation of the ligands 114, and then Zn²⁺ cations 116 are attracted and meet the deprotonated ligands 118, leading to the formation of ZIF-8 on the porous PP substrate 102. The top-view SEM images of ZIF-8 AED-coated 8 μm PP shown in FIGS. 4A and 4B clearly reveal the successful synthesis of a large-area crack-free ZIF-8 layer on the PP surface using the contemplated AED method.

The pristine PP separator shown in FIG. 4C possesses a highly strip-shaped porous structure, with the pore sizes ranging from several tens to hundreds of nanometers. This was densely covered by a thin ZIF-8 layer with a thickness of ˜ 1 μm, as verified by the cross-sectional SEM image shown in FIG. 4D. The obtained modification layer formed by crystalline ZIF-8 particles is even and homogeneous.

A lithium polysulfide diffusion test was performed for the ZIF-8 AED-coated 8 μm PP and 8 μm PP separators that were fabricated. The superior polysulfide barrier effect through the ZIF-8 AED-coated 8 μm PP was visually compared to the commercial 8 μm pristine PP separator by lithium polysulfide permeation measurements. Initially, the H-cell glass units coupled with the ZIF-8 AED-coated 8 μm PP and 8 μm pristine PP in the middle showed, respectively, 0.025 mol·L⁻¹ of Li₂S₆ electrolyte and blank electrolyte were filled into the right and left tubes, respectively. With the extension of the dwell time (24 hours), the Li₂S₆ had visibly diffused from right to left in the cases of the 8 μm pristine PP separators. In contrast, in the glass unit with ZIF-8 AED-coated 8 μm PP separator, almost no Li₂S₆ diffusion from the left tube to right tube was observed even after 24 h. This observation further implies that the 8 μm PP separator simply engineered by the cathodically deposited ZIF-8 surface layer has a strong application potential for LSBs.

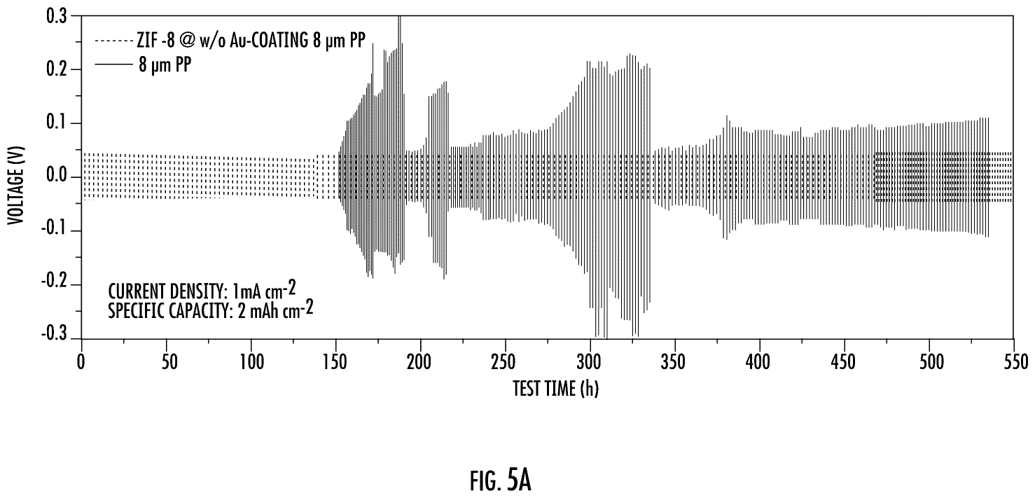

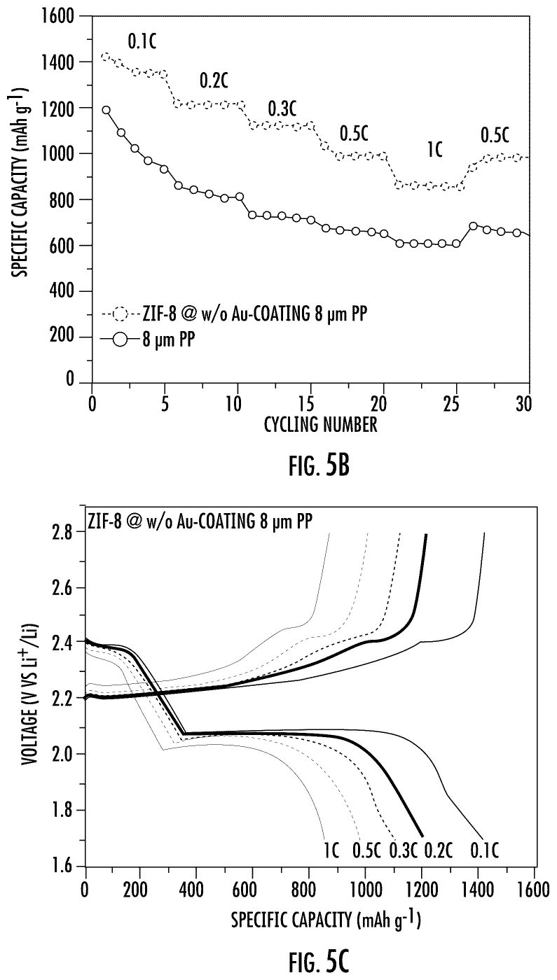

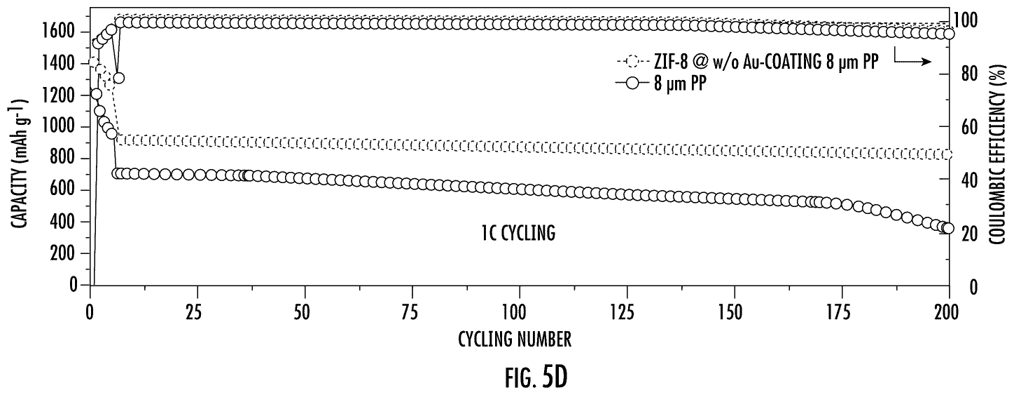

FIGS. 5A-5D shows various properties of ZIF-8 AED-coated 8 μm PP and commercial 8 μm PP. Specifically, FIG. 5A shows a lithium plating and stripping voltage profile using Li—Li symmetric cells. FIG. 5B shows the rate capabilities of Li—S full cells. FIG. 5C shows galvanostatic charge-discharge voltage curves for ZIF-8 AED-coated 8 μm PP from 0.1 to 1 C. FIG. 5D shows long-term cyclic stability of Li—S cells with different separators at 1 C.

Li-metal plating/stripping reversibility was assessed using a Li∥Li symmetric cell assembled with different separators, as depicted in FIG. 5A. Initially, a Li∥Li symmetric cell was evaluated using the ZIF-8 AED-coated 8 μm PP separator within a typical 1 M LiTFSI ether-based electrolyte. Even when subjected to a current rate of 2 mA/cm² for 1 hour of plating/stripping time, no significant voltage polarization or cell short circuiting was observed during an extended cycling time exceeding 550 hours. Conversely, the Li∥Li symmetric cell using an 8 μm pristine PP showed poor electrochemical performance, with a limited cycling time of 150 hours, substantial polarization, and cell short circuit occurrence.

To assess the suitability of the ZIF-8 AED-coated 8 μm PP separator in lithium-sulfur batteries (LSBs), a series of LSBs using ZIF-8 AED-coated 8 μm PP and bare 8 μm PP counterparts as separators were assembled and tested. Both the rate capability and cyclic performance were evaluated through galvanostatic charge/discharge measurements. As illustrated in FIG. 5B, batteries with ZIF-8 AED-coated 8 μm PP demonstrated an enhanced rate capability, particularly noticeable with increasing applied current density. The specific discharge capacities delivered by LSBs coupled with ZIF-8 AED-coated 8 μm PP were 1360, 1212, 1117, 992, and 858 mAh·g⁻¹ at current densities of 0.1 C, 0.2 C, 0.3 C, 0.5 C, and 1 C, respectively. Typical charge and discharge voltage profiles of LSBs assembled with ZIF-8 AED-coated 8 μm PP at different current densities (C-rates) are shown in FIG. 5C.

Additionally, FIG. 5D illustrates the cycling stability of LSBs coupled with ZIF-8 AED-coated 8 μm PP separator and pristine 8 μm PP at the 1 C-rate. This observation suggests that employing ZIF-8 AED-coated 8 μm PP as a MARS 300 helps in achieving high capacity and good cyclic stability, with a retained capacity of 826 mAh g⁻¹ after 200 cycles and a Columbic Efficiency exceeding 98.5%.

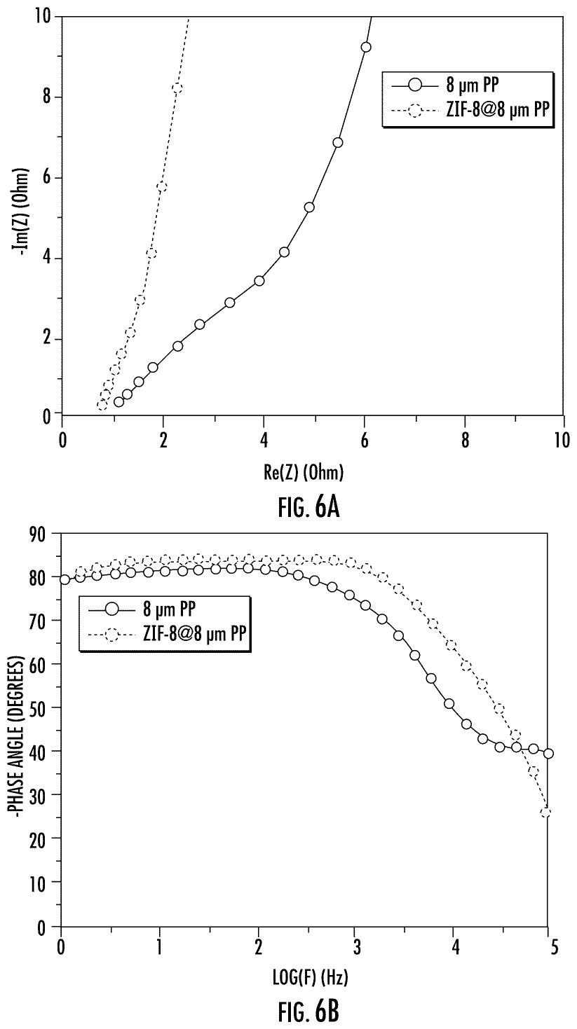

FIGS. 6A and 6B show the impedance spectra of supercapacitors with 1 M TEABF4 in acetonitrile as the electrolyte 306, with one using a ZIF-8 AED-coated 8 μm PP separator and another using a pristine 8 μm PP separator. Specifically, FIG. 6A is a Nyquist impedance plot, and FIG. 6B is a Bode phase angle plot. It is clear that with the ZIF-8 AED coating, the parasitic resistance is reduced, and the phase angle is improved.

It will be understood that implementations are not limited to the specific components disclosed herein, as virtually any components consistent with the intended operation of a method for the adjacent electrodeposition of a MOF coating on a porous substrate may be utilized. Accordingly, for example, although particular systems, methods, and/or devices for electrodeposition and characterization may be disclosed, such components may comprise any shape, size, style, type, model, version, class, grade, measurement, concentration, material, weight, quantity, and/or the like consistent with the intended operation of method for the adjacent electrodeposition of a MOF coating on a porous substrate may be used. In places where the description above refers to particular implementations of method for the adjacent electrodeposition of a MOF coating on a porous substrate, it should be readily apparent that a number of modifications may be made without departing from the spirit thereof and that these implementations may be applied to other electrochemical depositions on an insulating membrane.

What is claimed is:

1. A method for the adjacent electrodeposition of a metal-organic framework (MOF) on a porous membrane, comprising:
placing the porous membrane between a cathode and an anode in an electrodeposition setup with the porous membrane separated from the cathode by less than 6 mm;
introducing a solution comprising a ligand and a metal ion source into the electrodeposition setup, between the anode and the cathode; and
applying a bias to the cathode to reduce water and deprotonate the ligand thereby increasing a concentration of metal cations and deprotonated ligand anions between the porous membrane and the cathode, resulting in nucleation and growth of a MOF film directly on the porous membrane, the MOF film being conformal;
wherein the porous membrane is insulating.

2. The method of claim 1, wherein the porous membrane is one of polypropylene or polyethylene.

3. The method of claim 1, wherein the MOF is ZIF-8.

4. The method of claim 1, wherein the MOF is one of ZIF-67, Co—Zn bimetallic ZIF, MOF-5, HKUST-1, and UiO-66.

5. The method of claim 1, wherein the metal cations are Zn²⁺.

6. The method of claim 1, wherein the porous membrane is separated from the cathode by less than 1 mm.

7. The method of claim 6, wherein the porous membrane is in direct contact with the cathode.

8. The method of claim 1, wherein the ligand is 2-methylimidazole (MIM).

9. The method of claim 1, further comprising pre-seeding the porous membrane with MOF particles to facilitate MOF nucleation.

10. The method of claim 1, wherein the bias is a constant current.

11. The method of claim 1, wherein the bias is applied until a cutoff voltage is reached.

12. The method of claim 11, wherein the cutoff voltage is 2.5 V.

13. A method for the adjacent electrodeposition of a metal-organic framework (MOF) on a porous membrane, comprising:
placing the porous membrane between a cathode and an anode in an electrodeposition setup with the porous membrane separated from the cathode by less than 6 mm;
introducing a solution comprising a ligand and a metal ion source into the electrodeposition setup, between the anode and the cathode; and
applying a bias to the cathode to reduce water and deprotonate the ligand thereby increasing a concentration of metal cations and deprotonated ligand anions between the porous membrane and the cathode, resulting in nucleation and growth of a MOF film directly on the porous membrane, the MOF film being conformal;
wherein the porous membrane is polypropylene and is insulating;
wherein the MOF is ZIF-8;
wherein the metal cations are Zn²⁺; and
wherein the deprotonated ligand anions is 2-methylimidazolate (MIM⁻).

14. The method of claim 13, wherein the porous membrane is separated from the cathode by less than 1 mm.

15. The method of claim 14, wherein the porous membrane is in direct contact with the cathode.

16. The method of claim 13, wherein the bias is a constant current.

17. The method of claim 16, wherein the bias is applied until a cutoff voltage of 2.5 V is reached.

18. A method for assembling a lithium-metal anode-based battery cell, comprising:
fabricating a molecule active regulated separator (MARS) through the adjacent electrodeposition of a metal-organic framework on a porous membrane by:
placing the porous membrane between a cathode and an anode in an electrodeposition setup with the porous membrane separated from the cathode by less than 6 mm;
introducing a solution comprising a ligand and a metal ion source into the electrodeposition setup, between the anode and the cathode; and
applying a bias to the cathode to reduce water and deprotonate the ligand thereby increasing a concentration of metal cations and deprotonated ligand anions between the porous membrane and the cathode, resulting in nucleation and growth of a conformal MOF film directly on the porous membrane to form the MARS;
directly coupling the MARS to a lithium-metal anode (LMA) such that the MOF film of the MARS is mated with the LMA; and
completing the battery cell by introducing an electrolyte between the MARS and a battery cathode;
wherein the porous membrane is insulating.

19. The method of claim 18, wherein an interface between the MARS and the LMA is electrolyte-free.

20. The method of claim 18, wherein the MARS is less than 10 μm thick.
